(19) United States
(12) Patent Application Publication
(10) Pub. No.: US 2002/0160337 A1
(43) Pub. Date: Oct. 31, 2002

(54) Method of using computer data to modify or alter an existing cast or model

(76) Inventors: Michael Klein, Woodmere, NY (US); Michael Abrams, Roslyn, NY (US)

Correspondence Address: KATTEN MUCHIN ZAVIS ROSENMAN, 575 MADISON AVENUE, NEW YORK, NY, 10022-2585, US

(21) Appl. No.: 10/135,064

(22) Filed: Apr. 30, 2002

Related U.S. Application Data
(60) Provisional application No. 60/287,864, filed on Apr. 30, 2001.

(51) Int. Cl. A61C 11/00; A61C 8/00

(52) U.S. Cl. 433/213; 433/173

(57) ABSTRACT

A master cast or model for use in fabricating a dental prosthesis is created by modifying or altering a pre-existing cast or model using computer data derived from a CT scan. The use of such computer data eliminates the need to take an impression of a patient's oral anatomy following modification of such oral anatomy in preparation for the dental prosthesis.

### CROSS REFERENCE TO RELATED APPLICATION

This application claims the benefit under 35 U.S.C. §119(e) from provisional application No. 60/287,864 filed Apr. 30, 2001.

### FIELD OF THE INVENTION

This invention relates to a method of modifying a cast or model generally, and more particularly to a method of using computer data to modify or alter an existing anatomical model or cast to create a master cast upon which a prosthesis can be fabricated.

### BACKGROUND OF THE INVENTION

A master cast is generally used for the purpose of dental prosthesis fabrication. The term “dental prosthesis,” as used herein, generally refers to a dental restoration or a dental implant-supported restoration such as a bridge or a crown. The term “dental prosthesis” can also refer to any fixed (non-removable) or removable dental restoration. A dental patient in need of an implant-supported or implant-retained prosthesis will initially receive dental implant(s) for support of that prosthesis. Either immediately or sometime after the placement of the implants, a so-called “transfer impression” or so-called “pick-up” impression is usually made of the implants in the patient's mouth to form a so-called master cast. This master cast, in essence, duplicates the oral and dental anatomy of the patient's mouth as well as the three dimensional positions of the dental implants as they exist and appear in the patient's mouth.

Once the master cast is formed, a dental laboratory technician can use the master cast to fabricate a dental prosthesis that will fit to the patient's dental implants. The term “implant abutment,” as used herein, generally refers to a component that is attached to the head of a dental implant for the purpose of securing, supporting or retaining the dental prosthesis. From the aforementioned master cast, it is also possible to choose, choose and modify or fabricate the appropriate implant abutments for the patient. If it is necessary to modify the teeth in preparation to receive a dental prosthesis, the prepared tooth or teeth will also be present on the master cast for dental prosthesis fabrication. The current state of the art is that the patient's oral and/or dental anatomy is modified first and then, subsequent to that, an impression is made in the patient's mouth to create the master cast upon which a dental prosthesis will be made.

In the case of dental implants, a dental implant or implants are first placed into the patient's jawbone. Then, subsequently, a so-called “pick-up” or a so-called “transfer” impression is made of the dental implant or implants. A pick-up or transfer impression is made by first attaching components, called pick-up or transfer copings, to the implants in the mouth. Then, using impression material, an impression (this impression is also known as an implant-level impression) is made that will hold these pick-up or transfer copings in place. Implant analogs are then attached to the pick-up or transfer copings and, typically, dental stone is poured into the impression to create the master cast. This master cast is a (preferably) stone cast model or reproduction of the patient's oral and dental anatomy with implant analogs positioned precisely in the same three-dimensional position and orientation as the actual implants exist in the patient's mouth. Alternatively, implant abutments may first be attached to the implants and subsequently, an abutment-level impression is made from which a master cast is created.

Thus, the current state of the art for fabricating a master dental cast or model for dental implants involves the following steps:

1. Placement of dental implants into a patient's jawbone.

2. Attachment of transfer or pick-up components to the tops or heads of the dental implants. Alternatively, abutments or abutment components can be attached to the implants

3. Taking an implant-level impression or an abutment-level impression.

4. Attachment of implant analogs to the implant pick-up or transfer components in the implant-level impression. Alternatively, attachment of abutment analogs to an abutment-level impression.

5. Pouring up the implant-level impression in dental stone (or other stone, plaster, epoxy resin, acrylic or other polymeric material) to create the master cast.

Alternatively, pouring up the abutment-level impression to create the master cast.

In the prior art, placement of dental implants and/or modification of the patient's dental anatomy/teeth, existing prostheses, dental arch, oral anatomy, soft and/or hard tissue anatomy and the like, occurs prior to creation of a master cast. After dental implant placement and/or alteration of the patient's oral/dental anatomy by the dentist, an impression, as described above, is made to register the exact anatomic conditions and three-dimensional positions of the dental implants as they exist in the patient's mouth. The impression is subsequently poured up in dental stone (typically) to create the master cast. The master cast is then used by the laboratory technician to fabricate a dental prosthesis for the patient.

### SUMMARY OF THE INVENTION

In accordance with the method of the present invention, a master cast is created without taking an implant-level impression or abutment-level impression. In addition, the master cast may be created prior to implant placement. Such method is accomplished with the use of computer data to modify or alter an existing anatomical model or cast to create a master cast upon which a prosthesis can be fabricated. The same computer data will be used to modify or alter the same anatomic structure on the patient in the same exact or approximate exact manner. Thus, a master cast is created without having to go back to the patient to take an impression of the modified anatomic structure.

### BRIEF DESCRIPTION OF THE DRAWINGS

FIG. 1 illustrates an anatomical cast that is to be modified or altered in accordance with the method of the present invention.

FIG. 2 illustrates a CT (Computed Tomography) scan appliance for use in the method of the invention.

FIG. 3 illustrates the placement of the CT scan appliance of FIG. 2 onto the cast of FIG. 1.

FIG. 4 illustrates a computer-milled surgical template assembly for use in the method of the invention.

FIG. 5 illustrates the placement of the computer-milled surgical template assembly of FIG. 4 onto the cast of FIG. 1.

FIG. 6 illustrates the drilling of the cast of FIG. 1 through the computer-milled surgical template assembly of FIG. 4.

FIG. 7A illustrates the creation of one bore in the cast of FIG. 1.

FIG. 7B illustrates the creation of two bores in the cast of FIG. 1.

FIG. 8 illustrates a bore located in the cast of FIG. 1.

FIG. 9 illustrates an implant or implant replica installed in the bore of FIG. 7A.

FIG. 10 illustrates two implants or implant replicas installed in the bores of FIG. 7B.

FIG. 11 illustrates the positioning of a cast and CT scan appliance on a milling table in preparation for milling by a CNC (Computer Numerical Control) milling machine.

FIG. 12 demonstrates the assembly of FIG. 11 as it is positioned and ready for milling by a CNC milling machine.

FIG. 13 illustrates the milling of a cast to create bores for subsequent installation of implant or implant replicas.

FIG. 14 illustrates a bore created by a computer driven milling machine.

FIG. 15 illustrates a plurality of bores created by a computer driven milling machine.

### DETAILED DESCRIPTION OF THE PREFERRED EMBODIMENTS

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. In the various views of the drawings, like reference characters designate like or similar parts.

The use of computer data in connection with dental surgical procedures is known from the present inventors' U.S. Pat. No. 5,967,777, entitled “Surgical Template Assembly and Method for Drilling and Installing Dental Implants,” the disclosure of which is incorporated by reference herein. In such patent, a method is described that uses CT scan data to create computer-milled surgical templates for precision dental implant placement. Using available software, CT scan data of a patient's jawbone is reformatted to create interactive two and three dimensional views of a patient's jawbone, and dental implant simulations are created using such software. Thus, a virtual implant surgical simulation is created in two and three dimensional views. The three dimensional data coordinates of these dental implant simulations are transferred to a computer-controlled (CNC) milling machine. This milling machine subsequently mills a CT scan appliance in accordance with the said virtual implant surgical simulation. Drill guides are then mated with the computer-milled CT scan appliance to create the final computer-milled surgical template assembly.

In the present invention, a method is described that demonstrates how computer data is used to modify an existing stone (or plaster or the like) cast of a patient's oral and dental anatomy to create a master cast for the purpose of implant-supported dental prosthesis fabrication. The computer data can be CT scan data, reformatted CT scan data, modified CT scan data or the like. Other types of computer data are contemplated.

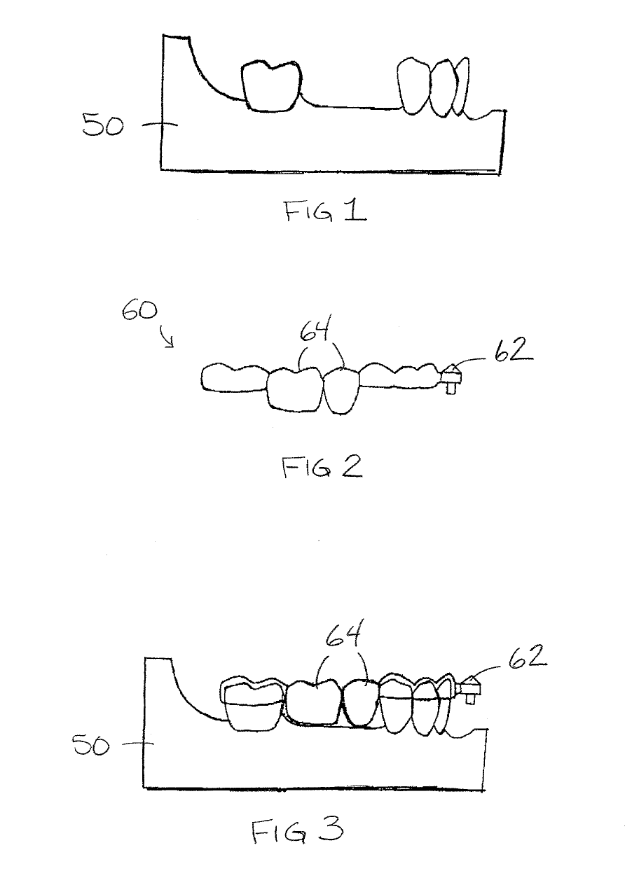

One embodiment of the inventive method of creating a master cast is described in connection with the appended figures. First, an impression is taken of the patient's jaw (not shown). Such impression is usually taken with a mold, although other types of impressions using alternative imaging techniques are contemplated. The impression is usually poured up in plaster or dental stone to create a cast 50 (FIG. 1) of the patient's existing oral/dental anatomy. Then, a CT scan appliance (FIG. 2) 60 with one or more fiducial markers 62 and radiopaque teeth 64 is fabricated in accordance with the teachings of U.S. Pat. No. 5,967,777. While the CT scan appliance 60 uses radiopaque teeth 64, other methods of radiopaque tooth identification are possible. FIG. 3 demonstrates how the CT scan appliance 60 interfaces or seats on the cast 50 of FIG. 1.

After the appliance 60 is created, a patient (not shown) wears the appliance 60 on the jaw it was fabricated for and gets CT scanned while wearing such appliance 60. The CT scan data is reformatted and a computerized virtual dental implant surgical plan (hereinafter “CT scan plan” or “implant positioning plan”) is created using available software. For example, a SIM/Plant® Plan may be created using SIM/Plant® software (see, for example, www.simplant.com). As described in the '777 patent, the three dimensional data coordinates of the implant surgical simulation plan are transferred to a CNC milling machine that computer mills the CT scan appliance to create a computer-milled surgical template. Subsequently, drill guide components 70 (FIG. 4) are mated with the CT scan appliance 60 to create a computer-milled surgical template assembly (CMSTA) 80.

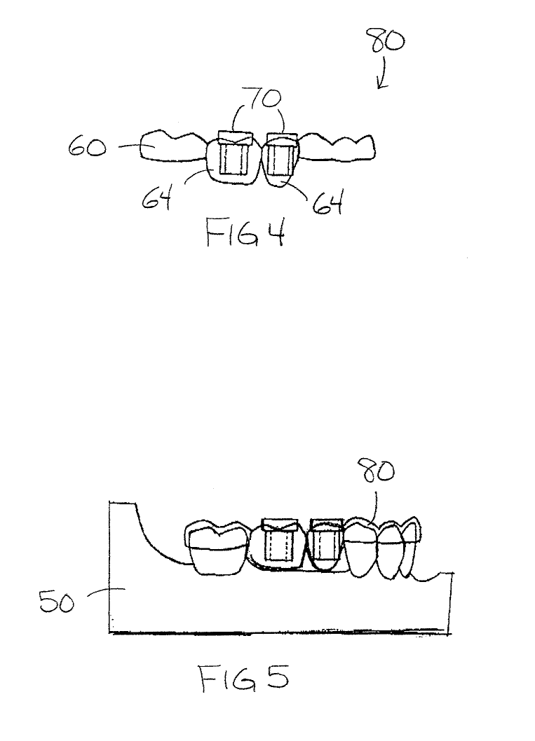

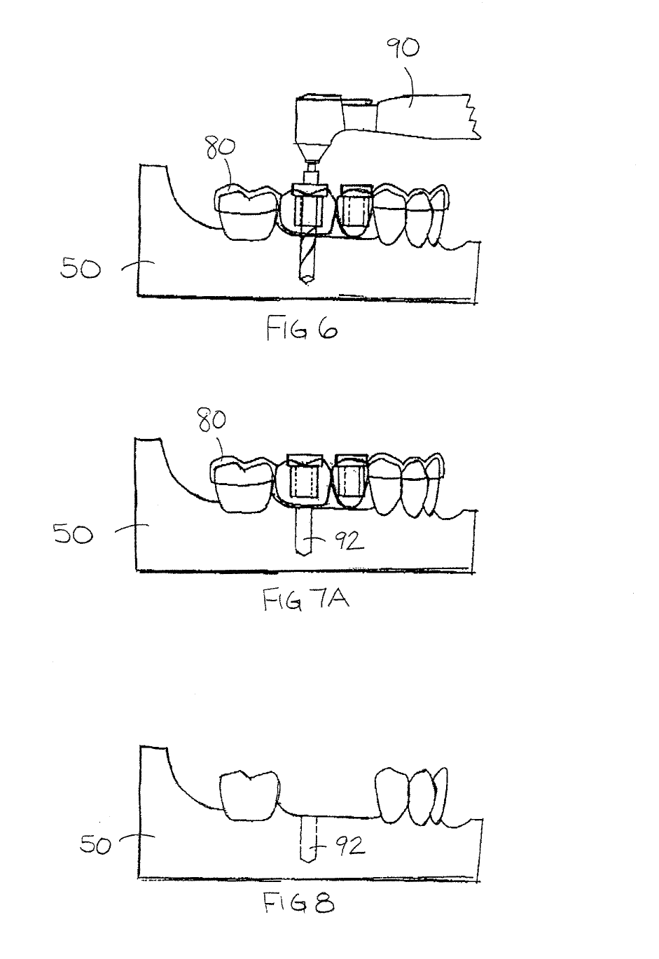

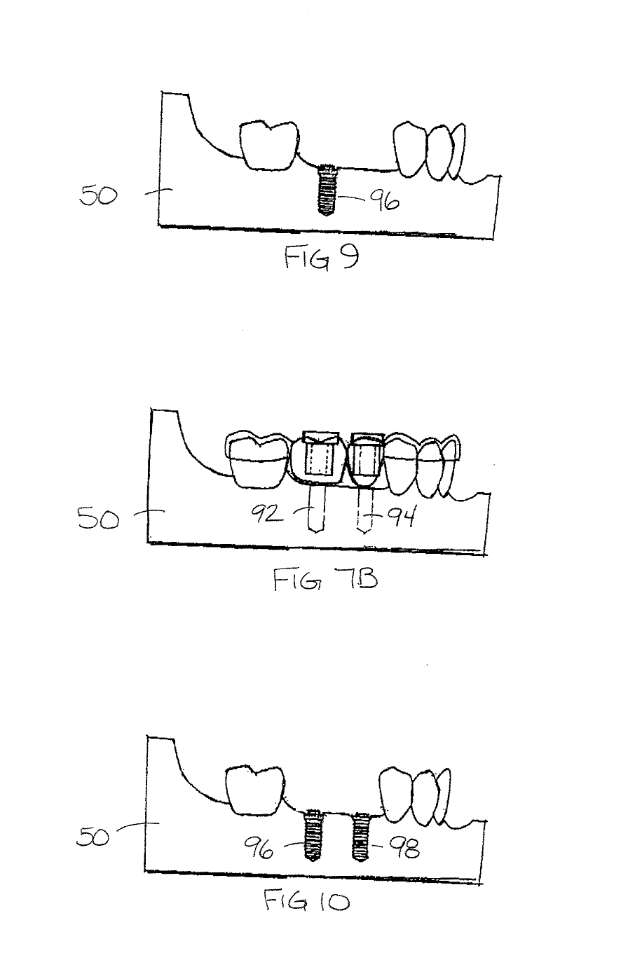

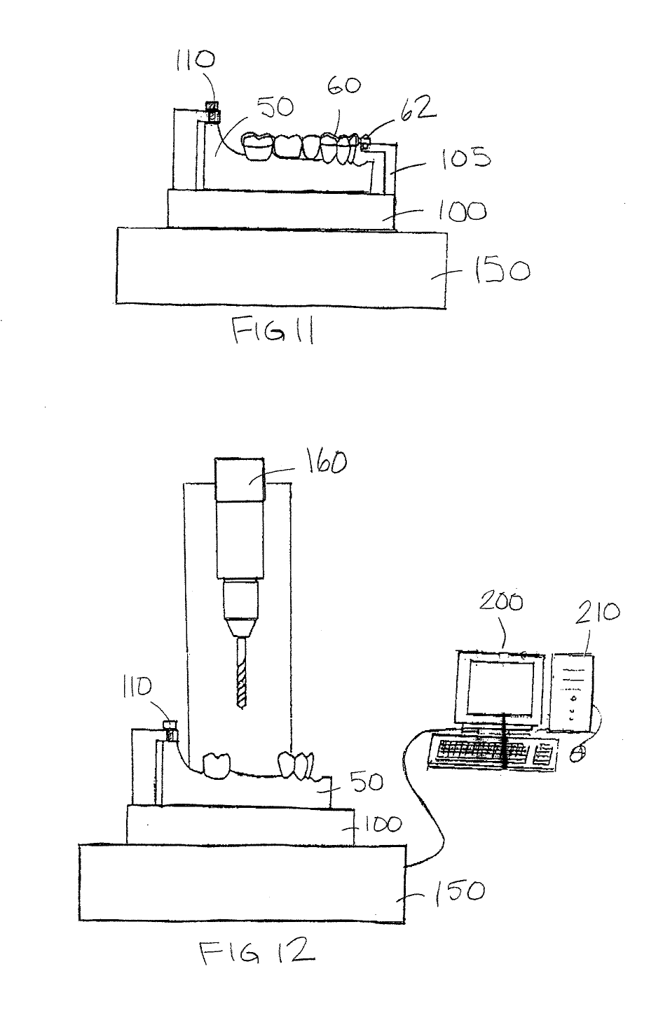

The CMSTA 80 is then placed back on the original cast 50 (FIG. 1) it was made on (FIG. 5) in preparation for modification of such cast 50. As shown in FIGS. 6-8, the drill guides 70 on the CMSTA 80 are used for guiding a handheld implant drill 90 and creating precision holes or bores 92 in the cast 50 that precisely replicate the positions of the dental implant simulations created using the CT scan data as discussed above. One bore 92 (FIG. 7A) or a plurality of bores (see FIG. 7B, for example) are created in accordance with the simulated implant plan. Implants, implant replicas or implant analogs 96, 98 (see FIGS. 9 and 10) are installed into these bores 92, 94 to create the master cast.

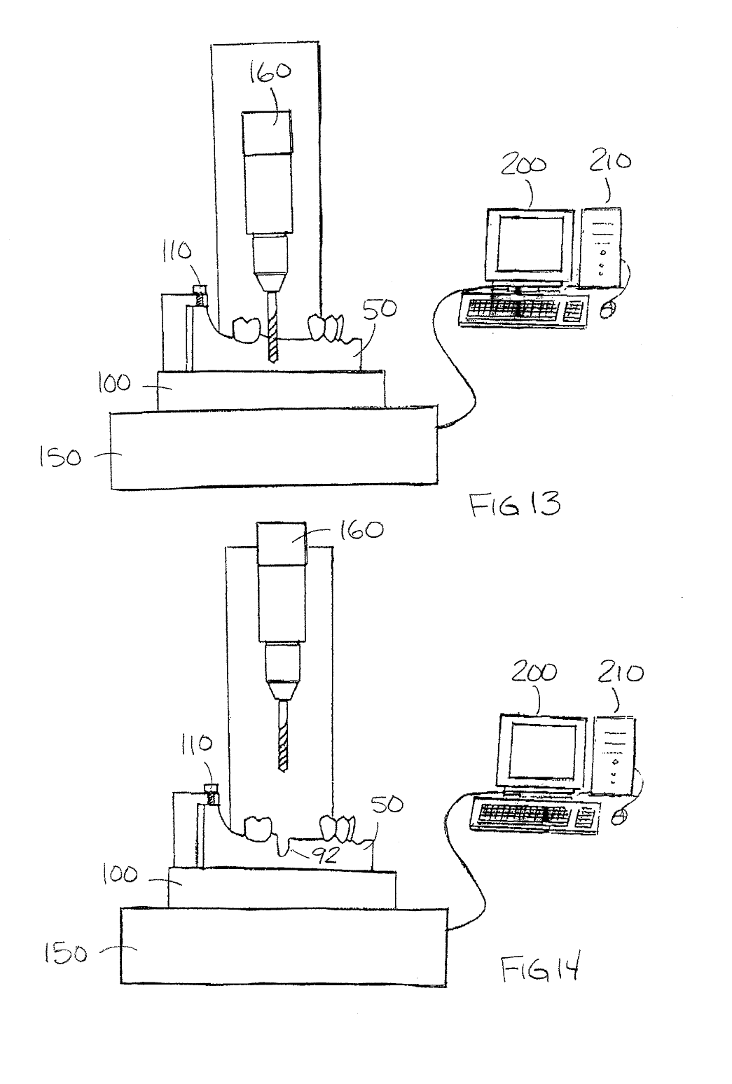

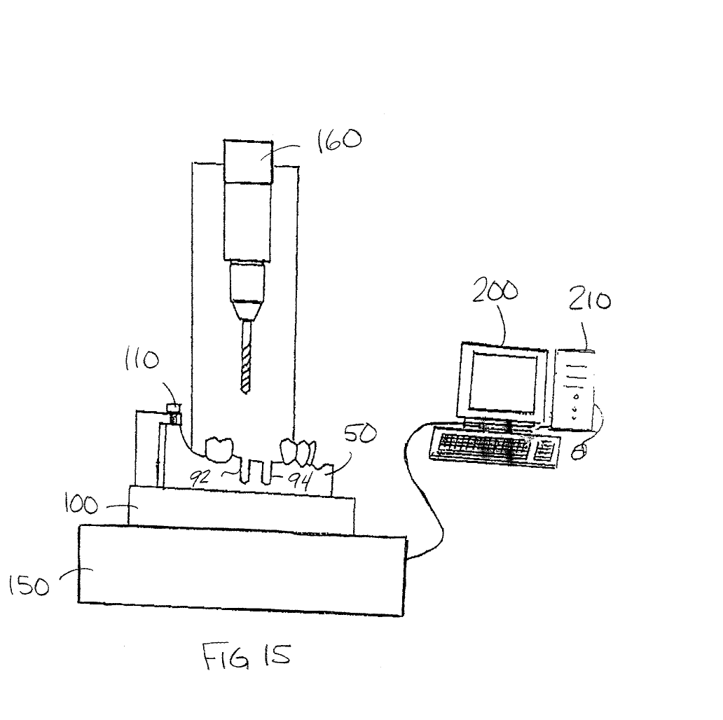

While CT scan data can be used to create a master cast manually as illustrated above, FIGS. 11-15 illustrate the creation of a master cast using a CNC milling machine. The cast or model 50 with the CT scan appliance 60 fitted thereon (FIG. 11; see also FIG. 3) is positioned on a milling table 100 of a CNC milling machine 150. The CNC milling machine 150 is interfaced with a computer 200 (FIG. 12) having a CT scan plan (such as a SIM/Plant® plan as discussed above) 210 loaded thereon. The cast 50 is three-dimensionally positioned on the milling table 100 through the connection of orientation fastener(s) 105 with the fiducial marker(s) 62 of the CT scan appliance 60. While the appliance 60 shows only one fiducial marker 62, it is preferable that three fiducial markers 62 are used to position and orient the CT scan appliance 60 and thus the cast 50 relative to the milling table 100. The cast 50 is secured and locked into place by one or more securing devices 110 or in combination with other securing means (such as plaster, adhesive or the like). Once the cast 50 is properly oriented, positioned and fastened, it is no longer necessary to have the CT scan appliance 60 positioned thereon and it is therefore removed (FIG. 12). Thereafter, a drill 160 of the CNC milling machine 150 is controllably driven (FIG. 13) by the CT scan plan 210 to mill a bore 192 (FIG. 14) or bores 192, 194 (FIG. 15) in the cast 50. Subsequently, implants, implant replicas or implant analogs are installed therein to create the master cast (see FIGS. 9 and 10).

While FIGS. 1-15 illustrate the method of utilizing computer data to hand drill or computer mill a cast 50 to create a master cast having one or two implant analogs, it will be appreciated that any number of bores may be created in accordance with the CT scan plan. Furthermore, it will be appreciated that any number of implant, implant replicas or implant analogs may be suitably fashioned into the bored cast to create the master cast.

These implants or implant analogs 96, 98 will now be in the same or approximately exact relative three-dimensional position as the implant simulations on the CT scan plan. Once the CMSTA 80 is used by the implant surgeon in accordance with the method of the '777 patent to position the actual dental implants on the patient, the three-dimensional positions of these implants now will coincide with the same three-dimensional positions as they exist on the mast cast (see FIGS. 9 and 10 for example) of the present invention.

A master cast created in accordance with the method of the present invention can be created before, during or after the actual dental implant placement surgery on the patient. The master cast created in accordance with the inventive method can be used to create a dental implant prosthesis prior to dental implant placement and without patient intervention. That is to say without having to go back to the patient following implant placement and take a pick-up or transfer impression to register implant position. Therefore, the use of reformatted CT scan data with an implant positioning plan allows for the creation of a CMSTA that enables the precision modification of a pre-existing dental cast of a patient's jaw in exactly or almost exactly the same manner as it will enable the modification of the actual patient's jaw at the time of surgery. That is to say, the method of the present invention enables the three-dimensional positioning of implants or implant replicas into the anatomic or dental cast of the patient in the same manner as it will enable the three-dimensional positioning of the actual implants on the patient. This model surgery (i.e. cast modification as described above) can be accomplished prior to the actual surgery on the patient, and therefore allows the creation of a master cast prior to the actual surgery on the patient. Thus, the fabrication of an implant-supported dental prosthesis or modification of components thereof can be achieved prior to the actual dental implant surgery on the patient.

The above description illustrates an example of how the method of the present invention can be applied to the field of dentistry and more specifically to the field of dental implantology. However, the use of computer data to alter an existing cast or model can also be applied in other areas with equal success. For instance, the inventive method can be applied in the field of orthopedic surgery. In such case, a cast or model of an anatomical structure, such as a femur or facial bone, can be modified using manipulated and reformatted CT scan data to create a master working anatomical cast or model upon which a prosthesis can be fabricated. The same CT scan data can be used at a later point in time to surgically modify the said anatomical structure in the same or approximately the same manner to receive, interface with or support the said prosthesis. For example, there may be a patient requiring an occular prosthesis, such patient having lost their eye and a substantial portion of their bony socket due to trauma or the like. The implementation of the technology of the present invention can occur as follows. The patient would have an impression made of their existing anatomy in the location of the anatomical deformity. From this impression, a plaster or stone cast would be fabricated depicting the existing anatomical morphology. A CT scan appliance with radiopaque reference markers suitable to the particular anatomy would then be fabricated upon this cast. The patient would now wear this CT scan appliance at the site of the anatomical deformity and receive a CT scan. The resulting CT scan data would now be reformatted and manipulated to create a simulated surgical plan for the insertion of bone-anchored implants. These anticipated bone-anchored implants will be installed for the purpose of supporting the occular prosthesis via snap attachments or the like. A CNC milling machine can now mill the CT scan appliance in accordance with the simulated surgical plan data in such a way as to precisely orient the orthopedic surgeon's drill to create bores in the patient's bone to receive the said bone-anchored implants. Either before, during or after the installation of the patient's occular implants, the milled CT scan appliance can be used in the same manner of the present invention to hand drill or CNC mill the original anatomical cast it was originally fabricated upon. Subsequently, implants or implant analogs can be installed into the said milled anatomical cast to create a master cast for the purpose of aiding in the fabrication of the occular prosthesis. Thus, in any site where a bone-anchored implant will be installed, the method of the present invention can be used to create a master cast for the purpose of aiding in the fabrication of an implant-supported prosthesis at that site.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention.

We claim:

1. A method for creating a master cast comprising the steps of:
a) taking an impression of a patient's anatomic structure,
b) forming an anatomic cast from said impression,
c) creating a reference appliance on said anatomic cast,
d) positioning said reference appliance to said patient's anatomic structure,
e) obtaining a CT scan of said reference appliance simultaneously with said patient's anatomic structure to produce CT scan data,
f) formatting said CT scan data to create formatted CT scan data,
g) using said formatted CT scan data to create an implant positioning plan, said implant positioning plan comprising three-dimensional coordinate data, and
h) using said implant positioning plan to modify said anatomic cast.

2. A method in accordance with claim 1, wherein said modifying said anatomic cast further comprises the step of creating one or more bores in said anatomic cast.

3. A method in accordance with claim 2, further comprising the step of hand-drilling said one or more bores in said anatomic cast.

4. A method in accordance with claim 3, further comprising the step of using said reference appliance to modify said anatomic cast.

5. A method in accordance with claim 1, further comprising the step of using said reference appliance to modify said anatomic cast.

6. A method in accordance with claim 5, further comprising the steps of using said implant positioning plan to computer mill one or more holes in said reference appliance and installing drill guides in said one or more holes of said reference appliance.

7. A method in accordance with claim 4, further comprising the step of creating said one or more bores through said reference appliance.

8. A method in accordance with claim 6, further comprising the step of drilling said one or more bores through said drill guides in said reference appliance.

9. A method in accordance with claim 8, further comprising the step of installing one or more implants in said one or more bores.

10. A method in accordance with claim 2, further comprising the step of installing one or more implants in said one or more bores.

11. A method in accordance with claim 10, wherein said one or more implants are implant replicas or implant analogs.

12. A method in accordance with claim 1, wherein said impression is a mold and said anatomic cast is formed by pouring stone into said mold.

13. A method in accordance with claim 1, wherein said anatomic cast is formed from one of stone, plaster, epoxy resin, acrylic or other polymeric material.

14. A method in accordance with claim 1, further comprising the step of positioning said anatomic cast on a milling table.

15. A method in accordance with claim 14, further comprising the step of placing said reference appliance on said anatomic cast and using said reference appliance to fix the three-dimensional position of said anatomic cast relative to said milling table.

16. A method in accordance with claim 15, wherein said reference appliance further comprises one or more fiducial markers, said fixing the three-dimensional position of said anatomic cast relative to the milling table further comprising the step of fixing said one or more fiducial markers relative to said milling table while said reference appliance is positioned on said anatomic cast.

17. A method in accordance with claim 16, wherein said one or more fiducial markers further comprises three fiducial markers.

18. A method in accordance with claim 17, further comprising the step of fastening said anatomic cast to said milling table and removing said reference appliance from said anatomic cast.

19. A method in accordance with claim 18, wherein said modifying said anatomic cast further comprises computer-driven machine modification of said anatomic cast.

20. A method in accordance with claim 19, wherein said computer-driven machine modification further comprises the use of use of a CNC milling machine to create said one or more bores in said anatomic cast in accordance with said implant positioning plan.

21. A method in accordance with claim 20, further comprising the step of installing one or more implants into said one or more bores.

22. A method in accordance with claim 2, wherein said modifying said anatomic cast further comprises the step of computer milling one or more bores into said anatomic cast.

23. A method in accordance with claim 22, further comprising the step of using a CNC machine to computer mill said one or more bores.

24. A method for creating a master cast comprising the steps of:
a) taking a three-dimensional impression of a patient's anatomic structure,
b) forming a three-dimensional anatomic cast from said impression,
c) creating a reference appliance on said anatomic cast,
d) positioning said reference appliance to said patient's anatomic structure,
e) obtaining a CT scan of said reference appliance simultaneously with said patient's anatomic structure to produce CT scan data,
f) formatting said CT scan data to create formatted CT scan data,
g) creating a three-dimensional implant positioning plan using said formatted CT scan data, said implant positioning plan comprising three-dimensional coordinate data,
h) creating one or more bores in said anatomic cast in accordance with said implant positioning plan, and
i) installing one or more implants in said one or more bores.

25. A method in accordance with claim 24, wherein said creating of said one or more bores further comprises the hand-drilling of said one or more bores through said reference appliance.

26. A method in accordance with claim 25, further comprising the installation of drill guides in said reference appliance to assist in the drilling of said one or more bores through said reference appliance.

27. A method in accordance with claim 26, wherein said anatomic cast is formed from one of stone, plaster, epoxy resin, acrylic or other polymeric material.

28. A method for creating a master cast comprising the steps of:
a) taking a three-dimensional impression of a patient's anatomic structure,
b) forming a three-dimensional anatomic cast from said impression,
c) creating a reference appliance on said anatomic cast, said reference appliance having one or more fiducial markers,
d) positioning said reference appliance to said patient's anatomic structure,
e) obtaining a CT scan of said reference appliance simultaneously with said patient's anatomic structure to produce CT scan data,
f) formatting said CT scan data to create formatted CT scan data,
g) creating a three-dimensional implant positioning plan using said formatted CT scan data, said implant positioning plan comprising three-dimensional coordinate data,
h) positioning said reference appliance on said anatomic cast,
i) positioning said anatomic cast on a milling table and fixing said position of said anatomic cast using said one or more fiducial markers,
j) removing said reference appliance from said anatomic cast,
k) using said implant positioning plan to CNC mill one or more bores in said anatomic cast, and
l) installing one or more implants in said one or more bores.

29. A method in accordance with claim 28, wherein said reference appliance further comprises three fiducial markers.

30. A method of installing dental implants in one or more desired implant locations on a patient comprising the steps of:
a) taking an impression of a patient's anatomic structure,
b) forming an anatomic cast from said impression,
c) creating a reference appliance on said anatomic cast,
d) positioning said reference appliance to said patient's anatomic structure,
e) obtaining a CT scan of said reference appliance simultaneously with said patient's anatomic structure to produce CT scan data,
f) formatting said CT scan data to create formatted CT scan data,
g) using said formatted CT scan data to create an implant positioning plan, said implant positioning plan comprising three-dimensional coordinate data,
h) using said implant positioning plan to install one or more implant replicas into said anatomic cast at locations that replicate said one or more desired implant locations and to confirm the anticipated positioning of said one or more dental implants in said patient,
i) using said reference appliance to drill one or more bores into said patient's anatomic structure at said one or more desired implant locations, and
j) installing dental implants into said one or more bores.
